(19) United States
(12) Patent Application Publication
(10) Pub. No.: US 2017/0058567 A1
(43) Pub. Date: Mar. 2, 2017

(54) LOCKING DEVICE FOR A DOOR OF A DOMESTIC APPLIANCE

(71) Applicant: Electrolux Appliances Aktiebolag, Stockholm (SE)

(72) Inventors: Branko Ivanovic, Rothenburg ob der Tauber (DE); Dietmar Hildner, Rothenburg ob der Tauber (DE); Arnd Hofmann, Rothenburg ob der Tauber (DE); Fabienne Reinhard-Herrscher, Rothenburg ob der Tauber (DE)

(21) Appl. No.: 15/119,193

(22) PCT Filed: Mar. 13, 2015
(86) PCT No.: PCT/EP2015/055255

§ 371 Date: Aug. 16, 2016

(30) Foreign Application Priority Data
Mar. 31, 2014 (EP) 14162744.8

(51) Int. Cl. E05B 47/00; D06F 37/28; A47L 15/42; F24C 15/02; D06F 58/20

(52) U.S. Cl. CPC E05B 47/0009; F24C 15/022; D06F 58/20; A47L 15/4259; D06F 37/28; E05B 2047/0068

(57) ABSTRACT

A locking device for a door of a domestic appliance, wherein—the locking device comprises a main body (10),—the locking device comprises a locking bar element (14) supported pivoting in and/or at the main body (10),—the locking bar element (14) is pivoting between an engaged position and a disengaged position,—the locking bar element (14) is engageable and disengageable with a corresponding counterpart,—the locking device comprises a shape memory wire (26),—the locking device comprises at least one means (18, 20) for supplying the shape memory wire (26) with electric current,—the electric current through the shape memory wire (26) effects a movement of the locking bar element (14) to the disengaged position,—the locking device comprises a return spring element (30) interconnected between the locking bar element (14) and the main body (10), and—the return spring element (30) effects a movement of the locking bar element (14) to the engaged position, wherein the shape memory wire (26) extends lineally and connects the locking bar element (14) to the main body (10), wherein the locking bar element (14) includes a lever arm (28), at which the shape memory wire (26) is fastened, so that a change in length of said shape memory wire (26) directly effects pivoting of the locking bar element (14) between the engaged and disengaged positions.

The present invention relates to a locking device for a door of a domestic appliance according to the preamble of claim 1. In particular, the domestic appliance is a cooking oven. Further, the domestic appliance may be a dishwasher, a washing machine or a tumble dryer.

Domestic appliances are equipped with a locking device for reasons of safety. The locking device prevents an opening of the door during the operating cycle of the domestic appliance. For example, the locking device is used on cooking ovens equipped with a pyrolytic self-cleaning function, wherein the locking device prevents an opening of the oven door at very high temperatures. Further, the locking device is also used for preventing the door being opened by children during normal operation of the oven.

A conventional locking device comprises a main body, a movable locking member and an actuation system. The main body is usually fastened to a chassis of the domestic appliance. The locking member is designed to interact with a retention element of the door.

It is also known that in certain situations there is the need to release the door of the domestic appliance manually. For example, in the case of malfunctioning of the actuation system the door must be released manually. Further, in the case of malfunctioning of the control system for the locking device or in the case of a fault in the electrical or electronic system of the domestic appliance, the door should be released manually.

As actuation system a wax electro-thermal motor, a solenoid or a stepper motor may be used. The main purpose of this actuation system is to provide a force and push some sliding elements, which interacts with pawls or hooks, and moves said sliding elements into the locked or unlocked position. Furthermore, the above said slider needs a co-operated return spring to push it into the engaged position to the above mentioned motor.

However, the known actuation systems require a relative long reaction time. Their structure is very complex, so conventional locking devices have large outer dimensions. The assembling and installation of known locking devices is complicated.

EP 2 518 243 A1 discloses a door locking device comprising a box body, a moveable carriage and a latch connected to said moveable carriage. An actuator comprises elastic thrust means designed to exert an elastic force on the moveable carriage. A shape memory wire extends like a serpentine and connects the box body to the moveable carriage. Also this locking device is very complex.

It is an object of the present invention to provide a locking device for a door of a domestic appliance, which locking device is engaged and disengaged fast, has a simply structure, has small outer dimensions, is easily assembled and installed and the movement of the actuation system is noiseless.

The object of the present invention is achieved by the door opening system according to claim 1.

According to the present invention the shape memory wire extends lineally and connects the locking bar element to the main body, wherein the locking bar element includes a lever arm, at which the shape memory wire is fastened, so that a change in length of said shape memory wire directly effects pivoting of the locking bar element between the engaged and disengaged positions.

The core of the present invention is the use of the shape memory wire and the connection of the locking bar element to said shape memory wire and to the casing via the return spring element, so that the change in length of the shape memory wire effects pivoting of the locking bar element between the engaged and disengaged positions. The term “engaged position” relates to the state of the opened door, in which the locking bar element is actually engaged with the corresponding counterpart, as well as to the state of the closed door, in which the locking bar element is not engaged with the corresponding counterpart, but in the same position relative to the locking device. The locking device with the shape memory wire has a simple structure and small outer dimensions. Said locking device is easily assembled and installed. The locking device with the shape memory wire allows a noiseless movement of the actuation system.

In particular, the locking device is provided for a chassis or a front frame of the domestic appliance, wherein the corresponding counterpart is formed in and/or at the door.

Preferably, the diameter of the shape memory wire is between 0.025 mm and 1.5 mm, preferably between 0.05 mm and 0.25 mm. This diameters cause a very fast reaction time of the shape memory wire, so that it can be preheated and cooled down very fast.

In an advantageous embodiment, the distance between the engaged position and the disengaged position of the locking bar element is at least 5 mm. Preferably, the shape memory wire is direct connected to the locking bar element, but far away from the pivoting point of said locking bar element.

Moreover, the locking device may comprise a silicone sleeve enclosing at least partially the shape memory wire. Said silicone sleeve reduces the time required for cooling down of the shape memory wire.

Further, the locking bar element may comprise an at least partially arched portion, which is designed to cooperate with an inclined surface in the corresponding counterpart, so that the locking bar element is pushable into the disengaged position by means of the inclined surface of the corresponding counterpart during a closing operation of the door.

Additionally, the locking device may comprise a door sensing slide element provided for detecting the presence or proximity of the door in a portion of the engaged position of the locking bar element.

Preferably, the door sensing slide element is constrained to the main body by a tension spring element.

Furthermore, the locking device may comprise a sensor switch activated or activatable by the door sensing slide element, if pushed by the door, wherein the sensor switch is connected and/or interfaced to a control system of the domestic appliance.

Preferably, the locking device comprises a cover element, wherein the main body and said cover element form a casing for the locking device. The main body and the cover element allow an easy assembling of the locking device.

Further, the main body and/or the cover element include ventilation openings for cooling down the shape memory wire. The ventilation openings, in particular ventilation slots, support a fast cooling down of the shape memory wire.

In particular, the shape memory wire is made of an alloy including nickel and titanium. Preferably, the shape memory wire is made of nickel-titanium-NOL. Alternatively, the shape memory wire is made of an alloy including nickel and titanium as well as copper, chrome and/or iron.

Preferably, the locking device comprises at least two electric terminals for supplying the shape memory wire with electric current.

At last the present invention relates to a domestic appliance including at least one door, wherein the domestic appliance comprises a locking device mentioned above.

Novel and inventive features of the present invention are set forth in the appended claims.

The present invention will be described in further details with reference to the accompanied drawings, in which

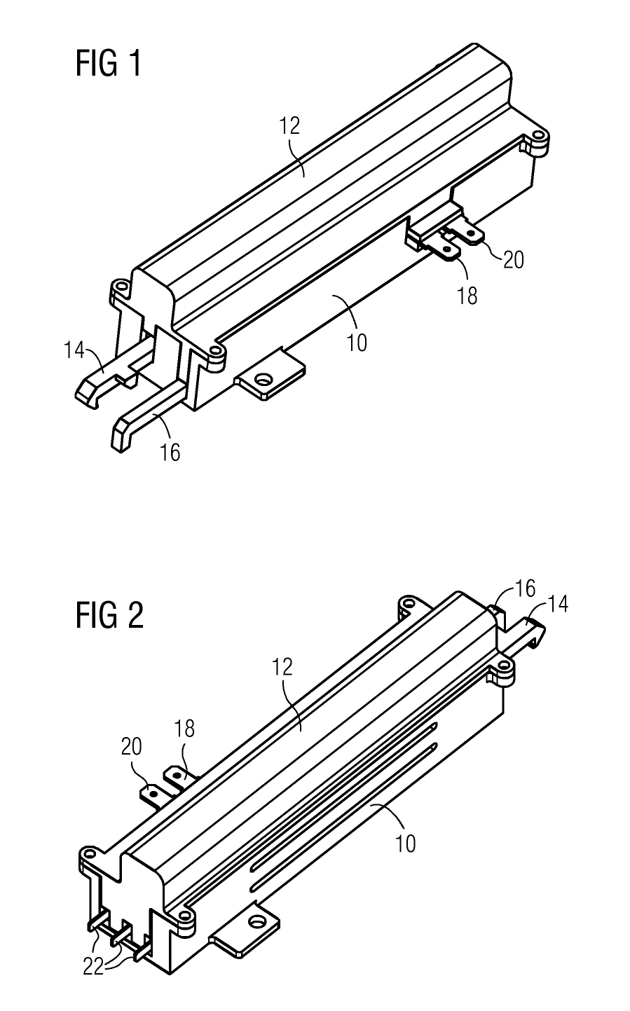

FIG. 1 illustrates a schematic perspective view of a locking device for a door of a domestic appliance according to a preferred embodiment of the present invention,

FIG. 2 illustrates another schematic perspective view of the locking device according to the preferred embodiment of the present invention,

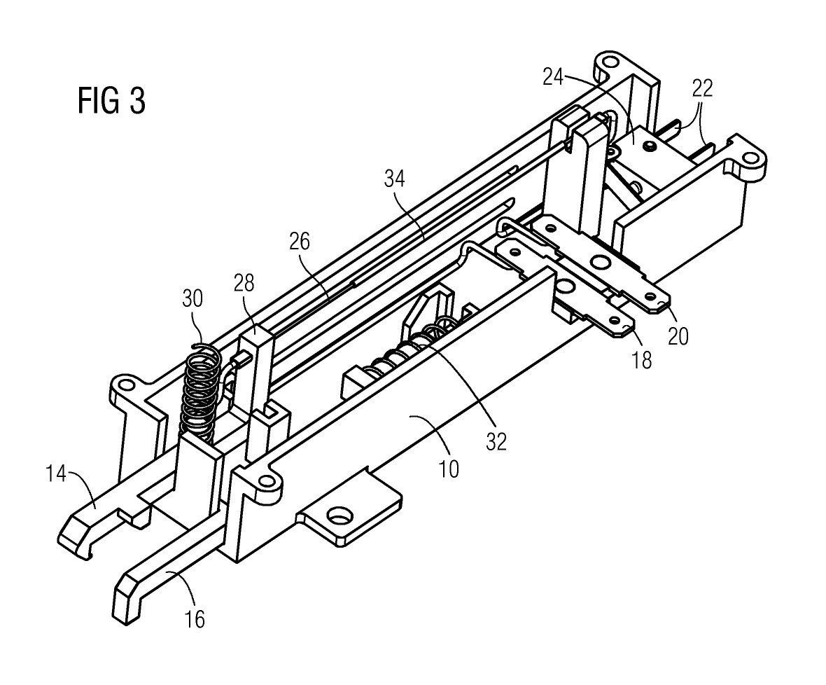

FIG. 3 illustrates a schematic perspective view of the opened locking device according to the preferred embodiment of the present invention, wherein a cover element is removed, and

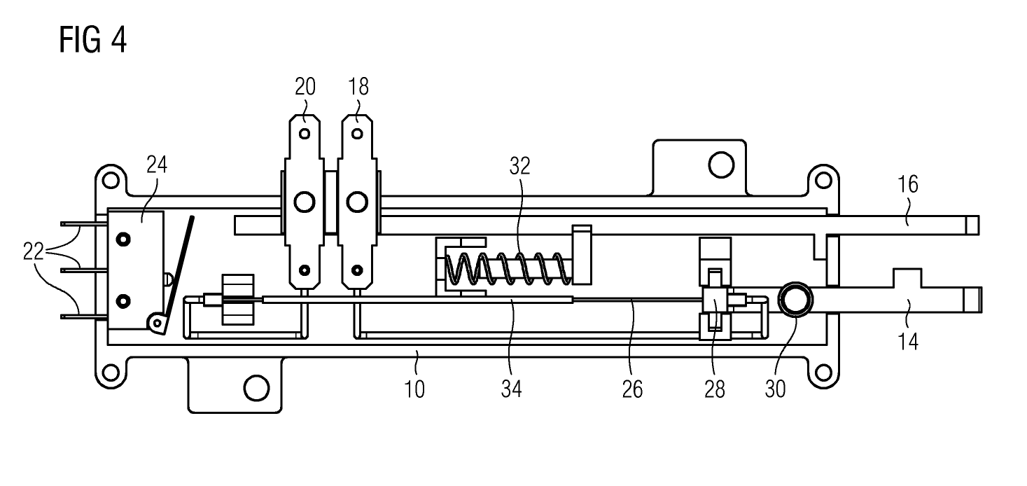

FIG. 4 illustrates a schematic top view of the opened locking device according to the preferred embodiment of the present invention, wherein the cover element is removed.

FIG. 1 illustrates a schematic perspective view of a locking device for a door of a domestic appliance according to a preferred embodiment of the present invention.

The locking device comprises a main body 10, a cover element 12, a locking bar element 14, a door sensing slide element 16, a first electric terminal 18 and a second electric terminal 20. The main body 10 forms a substantial and lower part of a casing for the locking device. The cover element 12 forms an upper part of the casing for the locking device. The locking bar element 14 is supported pivoting in the main body 10 and projects partially out of said main body 10. The door sensing slide element 16 is arranged movable inside the main body 10 and projects partially out of said main body 10. The first electric terminal 18 and the second electric terminal 20 are fixed in the main body 10 and project partially out of said main body 10.

For example, the main body 10 and the cover element 12 are made of moulded thermoplastic material. The main body 10 is designed to be fixed to a cabinet or chassis of the domestic appliance. The cover element 12 is fixed on the main body 10. The cover element 12 and the main body 10 form the casing of the locking device.

The locking bar element 14 is engageable with a recess in or at the door of the domestic appliance. The door sensing slide element 16 is provided for detecting the presence or proximity of the door of the domestic appliance. The first electric terminal 18 and the second electric terminal 20 are connected to a shape memory wire 26 arranged inside the main body 10. The shape memory wire 26 forms an electric actuator for the locking bar element 14. The first electric terminal 18 and the second electric terminal 20 are provided for the supply with electrical power of the shape memory wire 26.

FIG. 2 illustrates another schematic perspective view of the locking device according to the preferred embodiment of the present invention. FIG. 2 shows the opposite sides of the locking device in view of FIG. 1.

FIG. 2 shows also the main body 10, the cover element 12, the locking bar element 14, the door sensing slide element 16, the first electric terminal 18 and the second electric terminal 20 of the locking device. Additionally, the locking device comprises three switchable electric terminals 22 of a sensor switch 24. The sensor switch 24 is arranged inside the main body 10. The switchable electric terminals 22 are fixed at the sensor switch 24 and projects partially out of said main body 10.

FIG. 3 illustrates a schematic perspective view of the opened locking device according to the preferred embodiment of the present invention, wherein the cover element 12 is removed.

The locking bar element 14 is supported pivoting inside the main body 10 and projects partially out of said main body 10. On the one hand, the locking bar element 14 is connected to the main body 10 via the shape memory wire 26. On the other hand, the locking bar element 14 is connected to the main body 10 and/or to the cover element 10 via a spring element. In this example, the locking bar element 14 is connected to the cover element 10 via a return spring element 30 formed as a helical spring. The locking bar element 14 includes a lever arm 28, at which the shape memory wire 26 is fastened. The lever arm 28 extends upwards and is arranged perpendicular to the proper locking bar element 14. The shape memory wire 26 is at least partially enclosed by a silicone sleeve 34.

The locking bar element 14 is constrained-pivoted to the main body 10 as well as to the return spring element 30. The return spring element 30 moves the locking bar element 14 back into a locked position. In FIG. 3 the locked position of the locking bar element 14 is its lower position. Preferably, the locking bar element 14 and the return spring element 30 are made of metal.

If the shape memory wire 26 is supplied with electrical power, then the length of said shape memory wire 26 changes, so that the locking bar element 14 is pivoted into a position disengaged from the door. In FIG. 3 the disengaged position of the locking bar element 14 would be its upper position. In general, the shape memory wire 26 pulls or pushes the locking bar element 14.

Additionally, the return spring element 30 supports pulling back the shape memory wire 26 into its cold position during the cooling down cycle, in which the electrical power is switched off.

Further, the return spring element 30 is designed that the door is kept closed, even if some pulling force is applied on the door. The locking bar element 14 comprises a substantially arched rear portion, which has an end with a rounded profile and is designed to co-operate with an inclined surface in the mechanical structure of the door. Thus, the locking bar element 14 can be easily disengaged, i.e. pushed upwards by means of the mechanical structure of the door, during said door is closed.

The door sensing slide element 16 is arranged movable inside the main body 10. Further, the door sensing slide element 16 is constrained to the main body 10 by a tension spring element 32. In this example, the tension spring element 32 is a helical spring. The sensor switch 24 is activated by the door sensing slide element 16, if said door sensing slide element 16 is pushed into main body 10 against the resistance of the tension spring element 32. The sensor switch 24 is connected or interfaced to a control system of the domestic appliance. The tension spring element 32 pushes the door sensing slide element 16 back into the direction of the door. The door pushes the door sensing slide element 16 against micro switch during closing said door.

The sensor switch 24 and the door sensing slide element 16 have the function of detecting whether the door is in the correct opened position, independent of the operative condition of the locking bar element 14, in order to issue a command to the control system of the domestic appliance for deactivating the electrical power to the shape memory wire 26. As far as the door is closed, the control system of the domestic appliance can supply the power to the shape memory wire 26 and the door can be opened again.

The shape memory wire 26 is supplied by electric power via the first electric terminal 18 and the second electric terminal 20. Preferably, the shape memory wire 26 is made of nickel-titanium alloy and/or nickel-titanium-copper alloy. Shape memory alloys containing copper allows to reduce the transformation temperature range and the mechanical hysteresis. Furthermore, shape memory wire 26 can be made of nickel-titanium-chrome alloy as well as nickel-titanium-iron alloy. In particular, the shape memory wire 26 is made of nickel-titanium-NOL alloy. Nickel-titanium-NOL (nickel titanium Naval Ordnance Laboratory) is produced under special vacuum conditions.

The cross-section of the shape memory wire 26 may be square, rectangular, oval and semi-circular. Preferably, the cross-section of the shape memory wire 26 is circular. The shape memory wire with circular cross-section can be easily produced and assembled to the locking device. The diameter of the circular shape memory wire 26 is between 0.025 mm up to 1.5 mm and even more. A bigger diameter would have the disadvantage of a very long reaction time, which may be up to ten seconds or even more. Therefore, the preferred diameter of the circular shape memory wire 26 is between 0.05 mm and 0.25 mm. In this case, the shape memory wire 26 has a very fast reaction time, so that it can be preheated and cooled down very fast.

Furthermore, the preferred diameters mentioned above are designed for relative high application forces and a relative short stroke. A typical stroke is about 3.5% to 5% from the total length of the shape memory wire 26. In this example, the preferred length of the shape memory wire 26 is between 20 mm and 100 mm. Thus, a stroke between 1 mm and 8 mm it is very easy to lift the locking bar element 14 upwards.

In order to heat up the shape memory wire 26 to the working temperature, an electrical current between 0.2 A and 2.0 A is preferred.

In order to improve the reaction time of the shape memory wire 26 after actuation, there are some different cooling methods. For example, standard air convection may be provided. Further, forced air is obtained by openings, e.g. slots, in the main body 10 and/or cover element 12. Moreover, the silicone sleeve 34 enclosing the shape memory wire 26 allows an increased cooling time up to 10 times compared to the standard convection air cooling.

Furthermore, the smart design of the locking bar element 14 and its pivoting point, wherein the shape memory wire 26 is direct connected to the locking bar element 14, but far away from the pivoting point, allows the use of a very short shape memory wire 26 with a short stroke. At the same time the locking bar element 14 is lifted up to 5 mm or more. Further, the shape memory wire 26 may have a smaller diameter, since the locking bar element 14 may be easily lifted by a very low force.

Therefore, the diameter of the shape memory wire 26 up to 0.2 mm may be enough, since such as diameter is suitable for a drag force between 12 N and 20 N. The short shape memory wire 26 made of Nickel-Titanium-NOL alloy reduces the costs. Furthermore, the costs of the whole system are also reduced, since a shorter main body 10 and cover element 12 can be used.

The shape memory wire 26 is fixed by a crimp at the lever arm 28 of the locking bar element 14. Said crimp requires only a small space. Further, the crimp allows a strong pull-out force. For example, the crimp is of a T-type and of a ring-type. The shape memory wire 26 mentioned above is constrained at one side of the locking bar element 14. When the electric power is applied to the first electric terminal 18 and second electric terminal 20, then the shape memory wire 26 is getting shorter and pulls the locking bar element 14 into the upward and disengaged position. At the other side the shape memory wire 26 is constrained to the main body 10, so that the shape memory wire 26 cannot move. On both sides the shape memory wire 26 is fixed by the crimps mentioned above. The crimps are constrained to the shape memory wire 26 and main body 10 on the one side, and constrained to the shape memory wire 26 and the locking bar element 14 at the opposite side.

FIG. 4 illustrates a schematic top view of the opened locking device according to the preferred embodiment of the present invention, wherein the cover element 12 is removed. FIG. 4 clarifies the arrangements of the components in the locking device.

The locking bar element 14 is supported pivoting inside the main body 10 and projects partially out of said main body 10. The locking bar element 14 is connected to the main body 10 via the shape memory wire 26. Further, the locking bar element 14 is connected to the cover element 10 via the return spring element 30. Said return spring element 30 is formed as a helical spring. The lever arm 28 of the locking bar element 14 extends upwards. The shape memory wire 26 is fastened at said lever arm 28. The lever arm 28 is directed perpendicular to the proper locking bar element 14. The shape memory wire 26 is at least partially enclosed by the silicone sleeve 34.

The locking bar element 14 is constrained-pivoted to the main body 10 and to the return spring element 30. The return spring element 30 moves the locking bar element 14 back into the engaged position.

The locking device of the present invention allows that the door can be closed per hand and immediately engaged by means of the locking device and its locking bar element 14. Therefore, the time for engaging the door is very fast, e.g. less than 0.2 seconds. At the locking device of the present invention, the locking bar element 14 stays always at the engaged position, even after the door has being opened. During the closing operation of the door, the mechanical structure of said door moves the locking bar element 14 upward, and immediately after the door is pressed against a door gasket or a front frame the locking bar element 14 moves downward by means of the return spring element 30, so that the locking bar element 14 is engaged with the corresponding mechanical structure of the door.

In order to open the door the locking bar element 14 has to be moved upwards into the disengaged position. The locking bar element 14 is disengaged by the shape memory wire 26 and sets free the door. The shape memory wire 26 can pull or push the locking bar element 14 into the disengaged position.

The locking device of the present invention has a very simple structure, a low complexity and a less number of components. The shape memory wire 26 allows a very fast engaging and disengaging between the locking bar element 14 and the corresponding part of the door. The locking bar element 14 is activated after a time between 0.2 seconds and 0.5 seconds. In contrast, the conventional actuation systems require an activation time of about two seconds. The inventive locking device is noiseless and does not cause any EMC issues. The working temperature can be higher than 120° C. The outer dimensions of the inventive locking device are very small, so that the locking device requires less installation space. Further, the weight of said locking device is small. The energy consumption per activation is only about 2 Ws. In contrast, the energy consumption of the conventional actuation systems is about 8 Ws. The locking device of the present invention can be easily and quickly assembled and installed.

In a preferred example, the locking device can have a safety function in an oven during a pyrolytic cleaning process. In a similar way, the locking device may be provided for preventing the door being opened by children during normal cooking process of the oven.

Although an illustrative embodiment of the present invention has been described herein with reference to the accompanying drawing, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 main body
12 cover element
14 locking bar element
16 door sensing slide element
18 first electric terminal
20 second electric terminal
22 switchable electric terminal
24 sensor switch
26 shape memory wire
28 lever arm
30 return spring element
32 tension spring element
34 silicone sleeve

1. A locking device for a door of a domestic appliance, wherein
the locking device comprises a main body.
the locking device comprises a locking bar element supported pivoting in and/or at the main body,
the locking bar element is pivotable between an engaged position and a disengaged position,
the locking bar element is engageable and disengageable with a corresponding counterpart,
the locking device comprises a shape memory wire,
the locking device comprises at least one means for supplying the shape memory wire with electric current,
the electric current through the shape memory wire effects a movement of the locking bar element to the disengaged position,
the locking device comprises a return spring element interconnected between the locking bar element and the main body, and
the return spring element effects a movement of the locking bar element to the engaged position,
wherein the shape memory wire extends lineally and connects the locking bar element to the main body, wherein the locking bar element includes a lever arm, at which the shape memory wire is fastened, so that a change in length of said shape memory wire directly effects pivoting of the locking bar element between the engaged and disengaged positions.

2. The locking device according to claim 1, wherein the diameter of the shape memory wire is between 0.025 mm and 1.5 mm.

3. The locking device according to claim 1, wherein the distance between the engaged position and the disengaged position of the locking bar element is at least 5 mm.

4. The locking device according to claim 1, wherein the locking device comprises a silicone sleeve enclosing at least partially the shape memory wire.

5. The locking device according to claim 1, wherein the locking bar element comprises an at least partially arched portion, which is designed to cooperate with an inclined surface in the corresponding counterpart, so that the locking bar element is pushable into the disengaged position by means of the inclined surface of the corresponding counterpart during a closing operation of the door.

6. The locking device according to claim 1, wherein the locking device comprises a door sensing slide element provided for detecting the presence or proximity of the door in a portion of the engaged position of the locking bar element.

7. The locking device according to claim 6, wherein the door sensing slide element is constrained to the main body by a tension spring element.

8. The locking device according to claim 1, wherein the locking device comprises a cover element, wherein the main body and said cover element form a casing for the locking device.

9. The locking device according to claim 1, wherein the main body and/or the cover element include ventilation openings for cooling down the shape memory wire.

10. The locking device according to claim 1, wherein the shape memory wire is made of an alloy including nickel and titanium.

11. The locking device according to claim 1, wherein the shape memory wire is made of an alloy including nickel and titanium as well as copper, chrome and/or iron.

12. The locking device according to claim 1, wherein the locking device comprises at least two electric terminals for supplying the shape memory wire with electric current.

13. A domestic appliance including at least one door, and the locking device according to claim 1.

14. The domestic appliance according to claim 13, wherein the locking device is provided for a chassis or a front frame of the domestic appliance, wherein the corresponding counterpart is formed in and/or at the door.

15. The domestic appliance according to claim 13, wherein the locking device comprises a door sensing slide element provided for detecting the presence or proximity of the door ma portion of the engaged position of the locking bar element, and a sensor switch activated or activatable by said door sensing slide element, if pushed by the door, wherein the sensor switch is connected and/or interfaced to a control system of the domestic appliance.

16. The locking device according to claim 1, the diameter of the shape memory wire being between 0.05 mm and 0.25 mm.

17. The locking device according to claim 1, said shape memory wire being made of nickel-titanium-NOL.
